(19) United States
(12) Patent Application Publication
(10) Pub. No.: US 2008/0226214 A1
(43) Pub. Date: Sep. 18, 2008

(54) Roller Bearing

(75) Inventors: Guenther Glas, Schweinfurt (DE); Horst Doeppling, Herzogenaurach (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/088,741

(22) PCT Filed: Sep. 29, 2006
(86) PCT No.: PCT/DE2006/001734

§ 371 Date: Apr. 1, 2008

(30) Foreign Application Priority Data
Oct. 1, 2005 (DE) 10 2005 047 270.2

(51) Int. Cl. F16C 33/60; F16C 19/36; F16C 33/54; F16C 43/04

(52) U.S. Cl. 384/560

(57) ABSTRACT

The invention relates to a roller bearing comprising at least one internal ring, roller set and a cage, wherein the rollers are at least axially maintained by lateral walls of the cage, the internal ring comprises a roller running path in the form of a truncated cone outer jacket and a hollow cylindrical section of the internal ring forming an integral part therewith is connected on the axial continuation of the roller running path at least on the side of the small diameter of the truncated cone.

### FIELD OF THE INVENTION

The invention relates to a roller bearing comprising at least one inner race, a set of rollers and a cage, the rollers being at least axially held by means of side edges of the cage and the inner race having a roller raceway in the form of the outer lateral area of a truncated cone and the roller raceway axially adjoining, at least on the side with the small diameter of the truncated cone, a hollow-cylindrical portion of the inner race that is formed in one piece with the inner race.

### BACKGROUND OF THE INVENTION

The hollow-cylindrical portion on bearings of the known prior art is formed as a so-called minor flange. The minor flange serves as a stop for the cage or for the rolling elements. The inner race may also be adjoined on the side of the raceway with the greatest cone diameter by a so-called major flange. Both the minor flange and the major flange project radially beyond the roller raceway.

As a rule, the pockets of the cage are delimited in each circumferential direction by a web extending parallel to the axis of rotation of the bearing and in each axial direction by a circumferentially curved side edge. The side edges lying axially opposite one another are connected to one another by means of the webs, so that, if the cage were developed in a flat plane, a ladder-shaped profile would be obtained.

The rollers are generally held radially in the pockets of the cage, so that, when the outer race is not there, they are radially secured against being lost from the cage. In the axial direction, the set of rollers and the cage must be axially secured at least in the direction of the minor flange, since otherwise the set of rollers with the cage may be lost from the inner race or may slip off the inner race during operation because of the conical raceway.

The mounting of the individual parts, the inner race, the cage and the rolling elements, to form a structural unit that is secured against said parts being lost by coming apart is difficult due to the minor flange projecting radially beyond the roller raceway. During the assembly of the roller bearing, the parts are, for example, pushed over the so-called minor flange individually, as a set or while attached to the cage. For this assembly of the set of rollers on the inner race, there are alternatively various methods that are mentioned below.

When the rolling elements are pushed over the flange, they are radially deflected. In order that the rolling elements are not hindered from radial deflection in the pockets and can be deflected, for example the play in the pockets is chosen to be correspondingly great. This has a disadvantageous effect on the guiding and securing of the rollers in the roller bearing. Furthermore, the rollers may “sag” to such an extent within the greater radial play that they hinder the assembly of the outer race onto the set of rollers or the assembly of the inner race with the set of rollers into the outer race.

It is also conceivable to keep the radial height of the minor flange as small as possible, so that the rolling elements have to be deflected as little as possible. In such a case, the rollers are no longer adequately secured in the bearing or on the inner race and can fall out, in particular during assembly and transportation.

A further method of assembly, described in DE 197 24 068 A1, is that of first making the cage wider at the smaller diameter or keeping it greater in diameter from the outset. After inserting the rollers into the cage and onto the inner race, the cage is then narrowed radially on the widened side to the operating dimension. This method is used in particular in the case of cages made of sheet metal and requires additional expenditure and effort in terms of equipment and assembly. Furthermore, the side edge of the cage does not have a precisely circular shape after being narrowed. Among the properties that are optionally influenced by this are the running, sliding and guiding properties of the side edge or of the entire cage.

In particular in the case of cages made of plastic, there is also the possibility of introducing the rolling bodies into the cage over the minor flange by said cage first radially widening elastically until the rollers snap in radially behind the flange. In this case it is possible for the constraining forces to cause damage to the bearing at the flange, or at the cage, or at the roller raceways or at the rollers.

In other cases, the distances between the side edges in the pockets of the cage are made longer than the operating dimension. They are then considerably longer than is required by the axial length of the rollers and the axial operating play of the pockets, by an assembly dimension. In this case, the rollers, which are initially brought into position at an angle, can be axially placed in the cage. After that, at least one of the side edges is deformed in the direction of the rollers in such a way that the axial operating play of the pockets is set. This method is also used in particular in the case of cages made of sheet metal and, as already mentioned, requires additional expenditure and effort in terms of equipment and assembly. As described above, the deforming of one or both side edges possibly adversely influences the precise circular shape and the functional properties of the side edge or of the entire cage.

As an alternative to the method described above, after filling with the roller the axially over-large pocket is alternatively filled with corresponding intermediate pieces, which remain in the cage. The expenditure and effort for producing and assembling such cages is correspondingly great.

The production of the inner race, usually provided with a minor flange and a major flange, is relatively complex, and consequently expensive, since the latitude for working the raceway is restricted and since, for example, not only the raceway but also the flange must be ground correspondingly accurately.

If a tapered roller bearing mounted in a subassembly is to be serviced and inspected for further serviceability while in the assembled state, it is necessary to remove the tapered rollers from the raceway. Since the inner race of the bearings has the minor flange, this is generally not possible nondestructively if the outer race or the bearing seat shaft is to remain in its fitted position. Consequently, inspection, for example, of the state of wear of the roller raceway, and servicing of this kind are not possible.

### SUMMARY OF THE INVENTION

The object of the invention is therefore to provide a roller bearing that does not have the aforementioned disadvantages.

This object is achieved by the subject matter of claim 1 and further dependent claims. According to the invention, the greatest possible outside diameter of the portion is at most the same size as the smallest possible diameter of the truncated cone. Seated on the portion, at least radially on the outside, is an annular flange that is separate from the inner race. The smallest possible outer diameter of the flange is greater than the greatest possible small diameter of the truncated cone.

In the assembly of the roller bearing from the individual parts, the inner race, the rollers and the cage, first the set of rollers with the cage is pushed axially from the side of the roller raceway with the smallest diameter of the cone portion onto the inner race. As an alternative to this, the rollers are pushed axially in the same direction into the cage if the latter is already gripping around the inner race. Assembly can also be performed unhindered by the flange, since the flange is only put in place after the set of rollers has been assembled. The assembly of the roller bearing is greatly simplified. Depending on the configuration of the flange and the connection to the portion, the flange can also be easily removed again for inspection or servicing of the roller bearing. For the last-mentioned case, the use of a securing ring as the flange is recommendable for example.

One refinement of the invention provides that at least the side edge of the cage integrated with the rollers and with the inner race in the roller bearing that lies closest to the portion has a final form that is rigid and unaffected in comparison with an initial form of the side edge. The side edge has the initial form after the separate completion of the cage as an individual part, which is performed before the assembly of the roller bearing.

The cage as an individual part is produced for example as a turned part, as an injection-molded part or with preference as a formed sheet-metal part. The form of the side edge made to face the portion or radially facing the portion is precisely the same after the assembly of the rollers and the cage as before the assembly of the rollers, the inner race and the cage to form the roller bearing, since there is no need for the side edge to undergo any elastic or plastic change for or as a result of the assembly, because of the initially absent minor flange on the inner race.

Rollers are in this case to be understood as meaning all kinds of rollers such as cylindrical rollers, crowned rollers or mixed or special forms of these. A preferred refinement of the invention envisages tapered rollers.

For the purposes of the invention, a flange is to be understood as meaning any desired annular element that is separate from the inner race, after assembly on the inner race projects radially at least beyond the smallest diameter of the conical portion of the raceway and is suitable as a securing means preventing axial loss of the set of rollers with or without the cage and/or as an axial stop for the rollers during operation. In the simplest form, such flanges are, for example, securing rings of any desired form, which engage in the corresponding circumferential groove on the portion. The flange either directly adjoins the raceway or is separated from it by an axial distance. Alternatively, the flanges are solidly formed hollow-cylindrical rings, which are either pressed onto the portion or screwed on as screw elements, welded to the ring portion or connected to it in some other suitable way. The use of rings or caps made of plastic or the use of expediently shaped sheet-metal parts of any desired configuration is also conceivable.

The roller raceway is generally conically shaped. The conical shape, however, also comprises crowned or in some other way convexly, concavely or otherwise curved contours that are used in roller bearing technology within the generally conical shape.

The production of the inner race as an individual part is easier and less costly, since on the side of the raceway with the smallest diameter there is no flange formed in one piece with the material of the inner race and projecting beyond the raceway that hinders production. There is no longer any need for grinding of the annular portion.

### DETAILED DESCRIPTION OF THE DRAWING

The invention is explained in more detail below on the basis of exemplary embodiments.

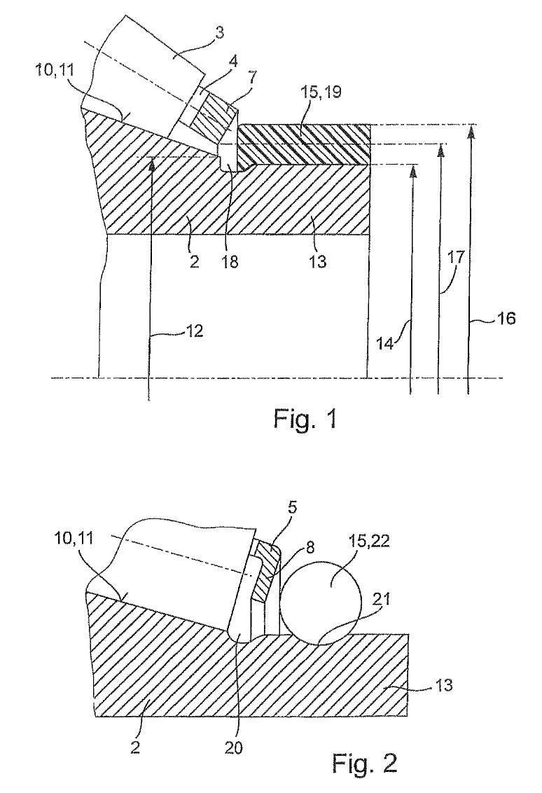

FIGS. 1 to 4 show simplified partial views of roller bearings in section along the axis of rotation 1.

The roller bearings have at least one inner race 2, a set of rollers 3 and a cage 4, 5 or 6, respectively. The rollers are optionally cylindrical or tapered rollers and are at least axially held by means of side edges 7, 8 or 9 of the respective cage 4, 5 or 6. The inner race 2 has a roller raceway 10 in the form of the outer lateral area 11 of a truncated cone. The roller raceway 10 axially adjoins on the side with the small diameter 12 of the truncated cone a hollow-cylindrical portion 13 that is formed in one piece with the inner race 2. Seated on the portion 13, radially on the outside, is an annular flange 15 that is separate from the inner race 2.

As shown in FIG. 1, as representative of the exemplary embodiments illustrated in FIGS. 1 to 4, the respective greatest possible outside diameter 14 of the portion 13 is at most the same size as the smallest possible diameter 12 of the truncated cone. The smallest possible outer diameter 16 of the flange 15 is greater than the greatest possible small diameter 12 of the truncated cone.

The cage has at the side edges 7, 8 and 9 at their radially narrowest point a smallest possible clearance 17, in this case in the form of an inside diameter that is greater than the outside diameter 14 of the portion 13 and less than the smallest possible outer diameter 16 of the flange 15.

The side edges 7, 8 and 9 of the cage 4, 5 and 6 integrated with the rollers 3 and with the inner race 2 in the roller bearing have a final form that is rigid and unaffected in comparison with an initial form of the respective side edge 7, 8 or 9. The form of the respective side edge 7, 8 or 9 has consequently remained unchanged since the production of the cage from steel sheet as an individual part.

The portion 13 as shown in FIG. 1 has in each case a recess in the form of an annular groove 18. The flange 15 of the exemplary embodiment of the invention that is represented in FIG. 1 is a plastic ring 19. Alternatively, the flange 15 is also formed as a solid steel ring or lightweight metal ring and engages in the annular groove 18.

The portion 13 as shown in FIG. 2 has a recess 20 and an annular groove 21 that is separate from the recess. The flange 15, in the form of a wire ring 22, engages in the annular groove 21. As an alternative to the wire ring 22, the use of any desired securing ring for shaft seats from the standard range of parts is envisaged.

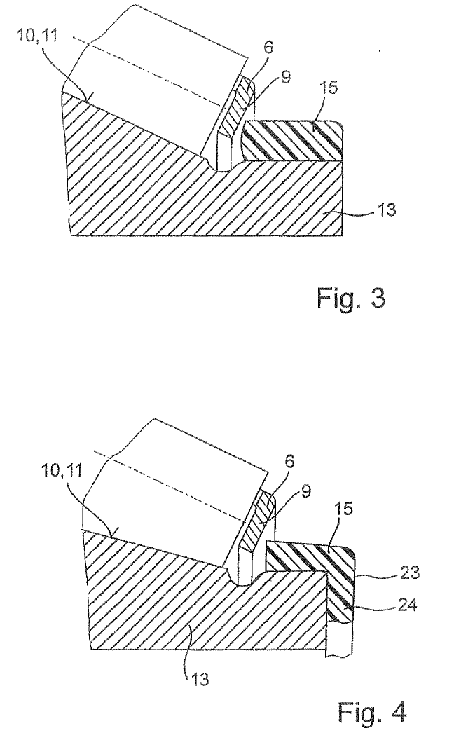

FIG. 3 shows an arrangement with a flange 15 made of sheet metal or solid material or of plastic, which is pressed onto the portion 13.

FIG. 4 shows a flange 15, which is a component part of a cap 23 made of sheet metal or of plastic. The flange 15 is pressed onto the portion 13 and continues axially at the extreme end, on a side facing away from the cage 6, in a disk portion 24 of the cap 23. The disk portion 24 at least partially covers the extreme end of the portion 13 and, for this purpose, is perforated or completely covers the portion 13 at the extreme end in the form of a circular plate.

### LIST OF DESIGNATIONS

1 axis of rotation
2 inner race
3 roller
4 cage
5 cage
6 cage
7 side edge
8 side edge
9 side edge
10 roller raceway
11 outer lateral area
12 small diameter of the truncated cone
13 hollow-cylindrical portion
14 outside diameter of the portion
15 flange
16 outer diameter of the flange
17 clearance at the radially narrowest point of the side edge
18 annular groove
19 plastic ring
20 recess
21 annular groove
22 wire ring
23 cap
24 disk portion

1. A roller bearing comprising at least one inner race, a set of rollers and a cage, wherein the rollers are at least axially held by means of side edges of the cage and wherein the inner race has a roller raceway in the form of the outer lateral area of a truncated cone, and the roller raceway axially adjoins at least on the side with the small diameter of the truncated cone a hollow-cylindrical portion of the inner race that is formed in one piece with the inner race, wherein the greatest possible outside diameter of the portion is at most the same size as the smallest possible small diameter of the truncated cone and in that seated on the portion, at least radially on the outside, is an annular flange that is separate from the inner race, the smallest possible outer diameter of the flange being greater than the greatest possible small diameter of the truncated cone.

2. The roller bearing of claim 1, wherein a smallest possible radially directed clearance between contours, lying radially opposite one another at the narrowest point, of one of the side edges that lies axially closest to the portion is greater than the outside diameter of the portion and less than the smallest possible outer diameter of the flange.

3. The roller bearing of claim 2, wherein at least the side edge of the cage integrated with the rollers and with the inner race in the roller bearing that lies closest to the portion has a final form that is rigid and unaffected in comparison with an initial form of the side edge, the side edge having the initial form after the completion of the cage as an individual part before the assembly of the roller bearing.

4. The roller bearing of claim 1, wherein the cage is made of steel.

5. The roller bearing of claim 1, wherein the cage is made of sheet metal.

6. The roller bearing of claim 1, wherein the portion has an annular groove, the flange at least partially engaging in the annular groove.

7. The roller bearing of claim 1, wherein the flange is pressed onto the portion.

8. The roller bearing of claim 1, wherein the flange is made of plastic.

9. The roller bearing of claim 1, wherein the flange continues axially at the extreme end, on a side facing away from the cage, in a disk portion, the disk portion at least partially covering the extreme end of the portion.

10. The roller bearing of claim 1, wherein the rollers are tapered rollers.
